(19) United States
(12) Patent Application Publication
(10) Pub. No.: US 2025/0253080 A1
(43) Pub. Date: Aug. 7, 2025

(54) CORE SUPPORT STRUCTURE

(71) Applicant: TDK CORPORATION, Tokyo (JP)

(72) Inventors: Satoshi KAWAMURA, Tokyo (JP); Akira IKEZAWA, Tokyo (JP); Kouji KANEKO, Tokyo (JP); Koichi KOBAYASHI, Tokyo (JP); Kenichi YAMAGUCHI, Tokyo (JP); Junpei SAWAYAMA, Tokyo (JP)

(73) Assignee: TDK CORPORATION, Tokyo (JP)

(21) Appl. No.: 18/854,133

(22) PCT Filed: Aug. 18, 2022
(86) PCT No.: PCT/JP2022/031228

§ 371 Date: Oct. 4, 2024

(51) Int. Cl. H01F 3/00

(52) U.S. Cl. CPC H01F 3/00

(57) ABSTRACT

A core support structure includes a first core; and a receiving member configured to receive the first core, and the receiving member has a bottom wall portion on which a bottom surface of the first core is placed and side wall portions facing side surfaces of the first core, and abutment avoidance portions that avoid abutment of the first core with corner portions are formed on at least one of the bottom wall portion and the side wall portions.

### TECHNICAL FIELD

The present disclosure relates to a core support structure.

### BACKGROUND ART

In a core used in an electronic device, there is a problem that a corner portion of the core rides on a corner R shape of a receiving member that receives the core, so that damage occurs or heat dissipation is deteriorated. In order to avoid such a problem, the corner portion of the core is chamfered to form a gap between the corner portion of the core and the corner R shape of the receiving member, thereby avoiding the rising of the corner portion of the core.

### CITATION LIST

### Patent Literature

Patent Literature 1: Japanese Unexamined Patent Publication No. 2015-12607

### SUMMARY OF INVENTION

### Technical Problem

However, when chamfering is provided at the corner portion of the core as described above, there is a problem that it is necessary to control processing and dimensions of the core. In addition, there is a problem that a volume of the core is reduced by the processing, a magnetic flux is reduced, and a shape of the core becomes asymmetric, so that directionality is obtained at the time of installation to the receiving member, and attention is required at the time of core attachment work.

An object of the present disclosure is to provide a core support structure capable of avoiding a corner portion of a core from riding on a receiving member without processing the core.

### Solution to Problem

A core support structure according to an aspect of the present disclosure includes a first core; and a receiving member configured to receive the first core, and the receiving member has a bottom wall portion on which a bottom surface of the first core is placed and a side wall portion facing a side surface of the first core, and an abutment avoidance portion that avoids abutment of the first core with a corner portion is formed on at least one of the bottom wall portion and the side wall portion.

In the core support structure according to the aspect of the present disclosure, the receiving member has the bottom wall portion on which the bottom surface of the first core is placed and the side wall portion facing the side surface of the first core. Therefore, the corner portion of the first core is disposed close to the corner portion between the bottom wall portion and the side wall portion. Here, at least one of the bottom wall portion and the side wall portion is formed with the abutment avoidance portion that avoids abutment of the first core with the corner portion. Therefore, even when the corner portion of the first core is not chamfered, it is avoided that the corner portion of the first core abuts on and rides on the corner R shape of the receiving member, and the first core is installed on the receiving member in a state of being placed on the bottom wall portion.

A second core disposed opposite to the first core may be further included, and the receiving member may be a spacer member disposed between the first core and the second core. In this case, since the first core can be avoided from riding on the receiving member, the size of a gap between the first core and the second core can be kept constant.

The abutment avoidance portion may be configured by a through-hole formed in the receiving member. In this case, the abutment avoidance portion can be provided with a simple configuration in which only the through-hole is formed in the receiving member.

The abutment avoidance portion may be configured by a groove portion formed in the receiving member. In this case, the abutment avoidance portion can be provided with a simple configuration in which only the groove portion is formed in the receiving member.

A through-hole in which a heat conduction member coupled to the first core is disposed may be formed in the receiving member. In this case, heat generated in the first core can be transferred to another member via the heat conduction member disposed in the through-hole.

### Advantageous Effects of Invention

According to the present disclosure, it is possible to provide a core support structure capable of avoiding corner portions of a core from riding on a receiving member without processing of the core.

### BRIEF DESCRIPTION OF DRAWINGS

FIG. 1 is a perspective view illustrating a core support structure according to the present embodiment of the present disclosure.

FIG. 2 is a cross-sectional perspective view of the core support structure according to the embodiment of the present disclosure.

FIG. 3 is an enlarged view of a cross section illustrated in FIG. 2.

FIG. 4 is a plan view of a spacer member.

FIG. 5 is a perspective view illustrating a core support structure according to a modification.

FIG. 6 is a cross-sectional view taken along line IV-IV illustrated in FIG. 5.

FIG. 7 is a plan view of the spacer member.

### DESCRIPTION OF EMBODIMENTS

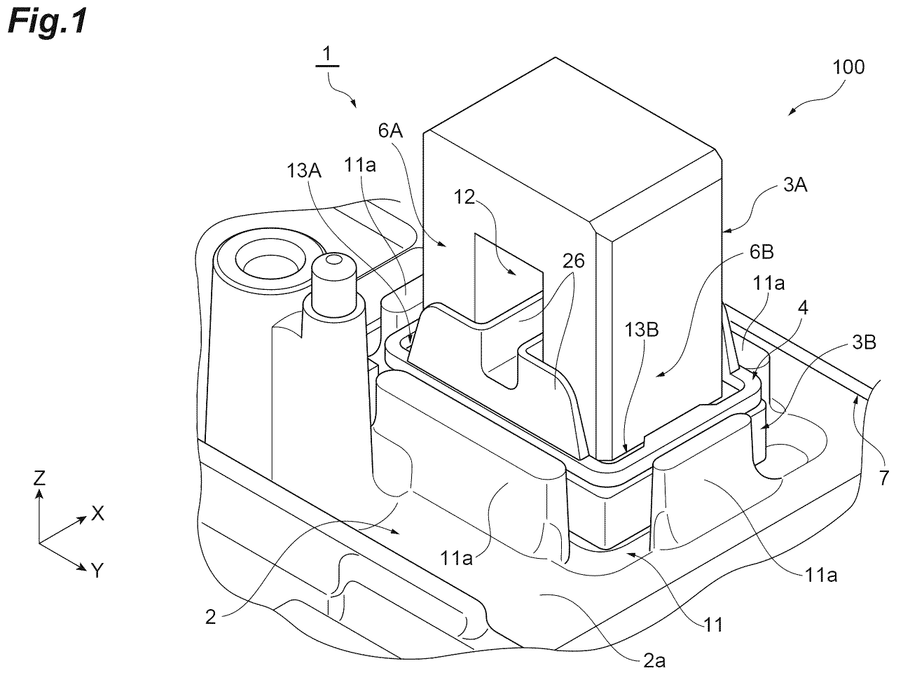

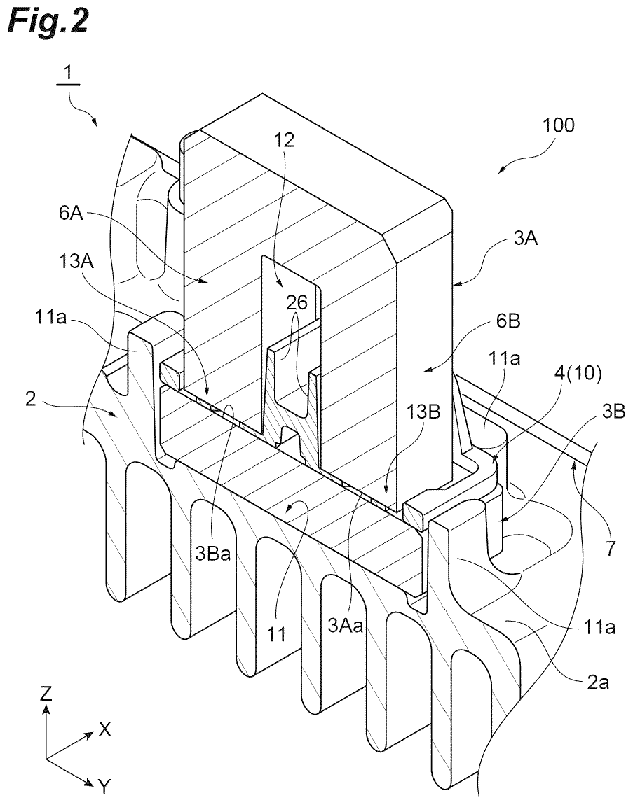

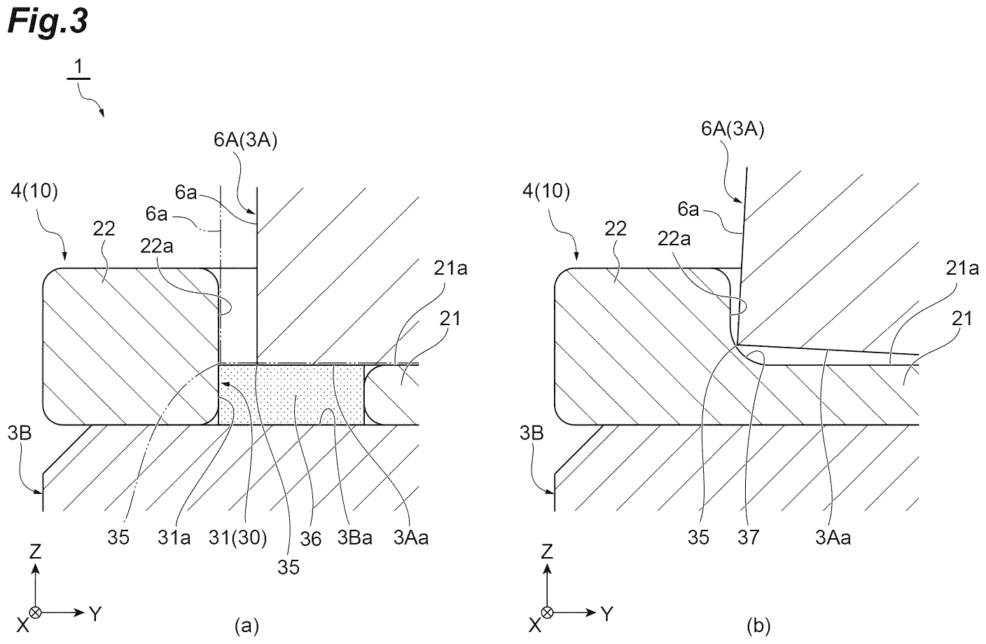

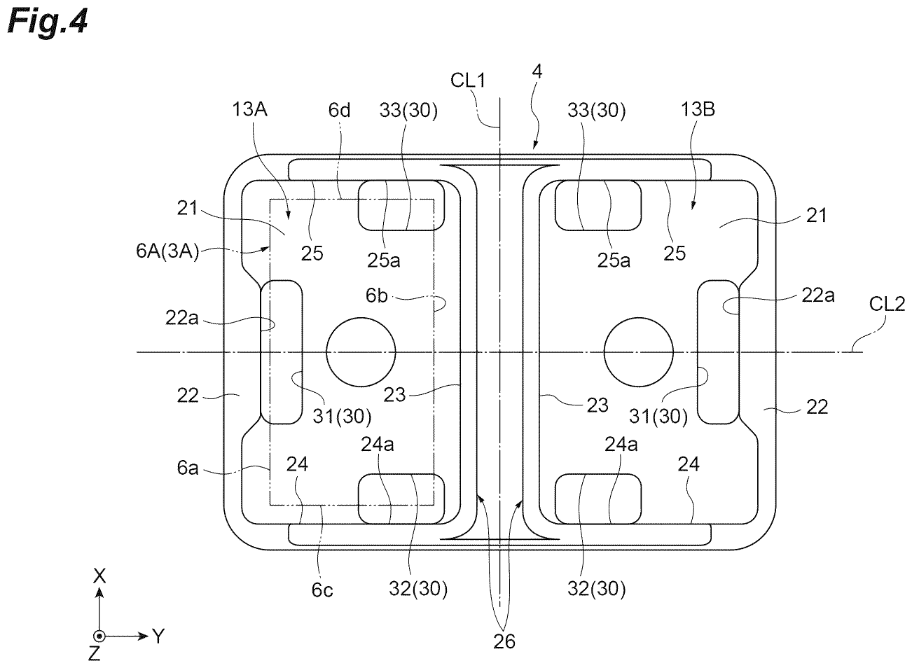

A core support structure 1 according to an embodiment of the present disclosure will be described with reference to FIGS. 1 to 4. FIG. 1 is a perspective view illustrating the core support structure 1 according to the present embodiment of the present disclosure. FIG. 2 is a cross-sectional perspective view of the core support structure 1 according to the embodiment of the present disclosure. FIG. 3 is an enlarged view of a cross section illustrated in FIG. 2. FIG. 4 is a plan view of the spacer member.

As illustrated in FIGS. 1 and 2, the core support structure 1 is a structure that supports a first core 3A and a second core 3B. The core support structure 1 is applied to, for example, an electronic unit 100 configured by housing a substrate, an electronic component, and the like in an internal space of a box-shaped housing body. Examples of the electronic unit 100 include a DC/DC converter, a charger, and an engine control unit (ECU). In FIGS. 1 and 2, a part of such an electronic unit 100 is illustrated. The electronic unit 100 includes the core support structure 1 at least partially. The core support structure 1 includes a base plate 2, the first core 3A, the second core 3B, a spacer member 4, and a substrate 7.

As illustrated in FIGS. 1 and 2, the base plate 2 is a structure that supports the first core 3A, the second core 3B, the spacer member 4, and the substrate 7. The base plate 2 is a member constituting a housing body that houses the above-described electronic unit. The base plate 2 has a main surface 2a that supports the components of the electronic unit. The base plate 2 has protrusions and groove portions on the main surface 2a that supports the components. Note that the following description may be made using XYZ coordinates. An X-axis direction and a Y-axis direction are directions orthogonal to each other, and are planar directions in which the base plate 2 extends. A Z-axis direction is a direction orthogonal to the X-axis direction and the Y-axis, and is a thickness direction of the base plate 2. The main surface 2a side in the Z-axis direction is a positive side. One side in the X-axis direction and the Y-axis direction is defined as a positive side, and the other side is defined as a negative side, respectively.

The second core 3B is an I-shaped core. The second core 3B is disposed on the main surface 2a of the base plate 2. The second core 3B is disposed on the negative side in the Z-axis direction with respect to the first core 3A. The second core 3B has a rectangular parallelepiped shape whose longitudinal direction is the Y-axis direction. A recess 11 for positioning the second core 3B in the X-axis direction and the Y-axis direction at the time of assembling the second core 3B is formed in the main surface 2a of the base plate 2. A main surface of the second core 3B on the negative side in the Z-axis direction is disposed in the recess 11 so as to be in contact with a bottom surface of the recess 11 (see FIG. 2). As a result, the second core 3B is positioned in the Z-axis direction with respect to the base plate 2 and is thermally coupled. Side wall portions 11a rising toward the positive side in the Z-axis direction are formed at four edge portions of the recess 11. At this time, four side surfaces of the second core 3B face four side wall portions 11a of the recess 11 with a slight gap therebetween. As a result, the second core 3B is positioned in the X-axis direction and the Y-axis direction with respect to the base plate 2.

The first core 3A is a U-shaped core. The first core 3A is disposed at a position on the positive side in the Z-axis direction with respect to the first core 3A. The first core 3A has a substantially rectangular parallelepiped shape. Further, the first core 3A has an inverted U-shape when viewed from the X-axis direction. The first core 3A has an opening 12 extending from a main surface 3Aa (see FIG. 2) on the negative side in the Z-axis direction to the positive side in the Z-axis direction. The opening 12 extends in a constant cross-sectional shape in the X-axis direction. The first core 3A has a leg portion 6A on the negative side in the Y-axis direction with respect to the opening 12 and a leg portion 6B on the positive side in the Y-axis direction with respect to the opening 12. The leg portions 6A and 6B each have a quadrangular prism shape. The main surface 3Aa of the first core 3A on the negative side in the Z-axis direction and a main surface 3Ba of the second core 3B on the positive side in the Z-axis direction face each other in the Z-axis direction while being separated from each other with the spacer member 4 interposed therebetween (see FIG. 2).

In the present embodiment, the second core 3B is the I-shaped core, and the first core 3A is the U-shaped core, but the cores are not limited to this combination of shapes, and may be a combination of U/U, E/I, or E/E cores.

As illustrated in FIGS. 1 and 2, the spacer member 4 is a member made of a material having insulating, nonmagnetic, and heat conductive properties and disposed between the first core 3A and the second core 3B.

The spacer member 4 is a portion that forms a gap between the first core 3A and the second core 3B. The spacer member 4 is configured as a receiving member 10 that receives the first core 3A. The spacer member 4 has a rectangular plate-like shape extending parallel to an XY plane. The spacer member 4 is interposed between the first core 3A and the second core 3B so as to be in contact with the main surface 3Bb of the second core 3B on the positive side in the Z-axis direction and the main surface 3Aa of the first core 3A on the negative side in the Z-axis direction (see FIG. 3). As a result, a constant core gap corresponding to a thickness of the spacer member 4 is formed between the leg portions 6A and 6B of the first core 3A and the second core 3B. As a result, the second core 3B is magnetically (and thermally) coupled to the first core 3A via the resin spacer member 4.

The spacer member 4 includes a housing portion 13A that houses the leg portion 6A of the first core 3A and a housing portion 13B that houses the leg portion 6B. In the spacer member 4A, a region on the negative side in the Y-axis direction is the housing portion 13A, and a region on the positive side in the Y-axis direction is the housing portion 13B. As illustrated in FIG. 4, the spacer member 4 has a symmetrical configuration with respect to a center line CL1 in the Y-axis direction, and has a symmetrical configuration with respect to a center line CL2 in the X-axis direction. Therefore, in the following description, the housing portion 13A will be described, and the description of the housing portion 13B will be omitted.

As illustrated in FIG. 4, the spacer member 4 has a bottom wall portion 21 and side wall portions 22, 23, 24, and 25. The bottom wall portion 21 is a wall portion on which the main surface 3Aa which is a bottom surface of the first core 3A is placed. The bottom wall portion 21 is a rectangular wall portion extending parallel to a YX plane. The side wall portions 22, 23, 24, and 25 are provided at four edge portions of the bottom wall portion 21 so as to extend along the edge portions and to extend toward the positive side in the Z-axis direction.

The side wall portion 22 extends in parallel to the X-axis direction at an edge portion of the bottom wall portion 21 on the negative side in the Y-axis direction. As a result, the side wall portion 22 faces a side surface 6a of the leg portion 6A of the first core 3A on the negative side in the Y-axis direction, in the Y-axis direction. The side wall portion 23 extends in parallel to the X-axis direction at an edge portion of the bottom wall portion 21 on the positive side in the Y-axis direction. As a result, the side wall portion 23 faces the side surface 6b of the leg portion 6A of the first core 3A on the positive side in the Y-axis direction, in the Y-axis direction. The side wall portion 24 extends in parallel to the Y-axis direction at an edge portion of the bottom wall portion 21 on the negative side in the X-axis direction. As a result, the side wall portion 24 faces a side surface 6c of the leg portion 6A of the first core 3A on the negative side in the X-axis direction, in the X-axis direction. The side wall portion 25 extends in parallel to the Y-axis direction at an edge portion of the bottom wall portion 21 on the positive side in the X-axis direction. As a result, the side wall portion 25 faces a side surface 6d of the leg portion 6A of the first core 3A on the positive side in the X-axis direction, in the X-axis direction.

The side wall portion 22 on the negative side in the Y-axis direction has a restricting portion 22a that protrudes toward the positive side in the Y-axis direction at a central position in the X-axis direction. When the leg portion 6A of the first core 3A is moved toward the negative side in the Y-axis direction, the restricting portion 22a comes into contact with the side surface 6a of the leg portion 6A on the negative side in the Y-axis direction to restrict the movement. Note that the movement of the first core 3A toward the positive side in the Y-axis direction is restricted by the restricting portion 22a of the housing portion 13B.

The side wall portion 24 on the negative side in the X-axis direction has a restricting portion 24a that protrudes toward the positive side in the X-axis direction at a position closer to the positive side in the Y-axis direction. When the leg portion 6A of the first core 3A is moved toward the negative side in the X-axis direction, the restricting portion 24a comes into contact with the side surface 6c of the leg portion 6A on the negative side in the X-axis direction to restrict the movement. The side wall portion 25 on the positive side in the X-axis direction has a restricting portion 25a that protrudes toward the negative side in the X-axis direction at a position closer to the positive side in the Y-axis direction. When the leg portion 6A of the first core 3A is moved toward the positive side in the X-axis direction, the restricting portion 25a comes into contact with the side surface 6d of the leg portion 6A on the positive side in the X-axis direction to restrict the movement. The side wall portions 23, 24, and 25 have rising portions 26 further rising toward the positive side in the Z-axis direction (see FIGS. 1 and 2).

The bottom wall portion 21 is formed with abutment avoidance portions 30 that avoid abutment of the first core 3A with the corner portions. In the present embodiment, the abutment avoidance portions 30 are formed at three locations. A first abutment avoidance portion 30 is configured by a through-hole 31 formed at a position corresponding to the restricting portion 22a. The through-hole 31 is formed at a position adjacent to the restricting portion 22a on the positive side in the Y-axis direction. The through-hole 31 avoids abutment of a corner portion between the bottom surface of the leg portion 6A of the first core 3A and the side surface 6a. A second abutment avoidance portion 30 is configured by a through-hole 32 formed at a position corresponding to the restricting portion 24a. The through-hole 32 is formed at a position adjacent to the restricting portion 24a on the positive side in the X-axis direction. The through-hole 32 avoids abutment of a corner portion between the bottom surface of the leg portion 6A of the first core 3A and the side surface 6c. A third abutment avoidance portion 30 is configured by a through-hole 33 formed at a position corresponding to the restricting portion 25a. The through-hole 33 is formed at a position adjacent to the restricting portion 25a on the positive side in the X-axis direction. The through-hole 33 avoids abutment of a corner portion between the bottom surface of the leg portion 6A of the first core 3A and the side surface 6d.

Next, the abutment avoidance portion 30 will be described in more detail with reference to FIG. 3(a). Although the through-hole 31 among the three abutment avoidance portions 30 will be described in FIG. 3(a), similar operations can be obtained for the other through-holes 32 and 33. As illustrated in FIG. 3(a), the abutment avoidance portion 30 is a portion that avoids abutment of the first core 3A with the corner portion 35 at the corner portion between the side wall portion 22 and the bottom wall portion 21. The through-hole 31 constituting the abutment avoidance portion 30 penetrates the bottom wall portion 21 in the Z-axis direction at a position adjacent to the restricting portion 22a of the side wall portion 22. An outer peripheral surface 31a of the through-hole 31 on the negative side in the Y-axis direction is a surface in which the surface of the restricting portion 22a is continuous to the negative side in the Z-axis direction so as to form the same plane as the surface of the restricting portion 22a. Since the spacer member 4 is a resin molded article, a corner R shape (see a corner R shape 37 in FIG. 3(b)) is formed on surfaces intersecting each other. However, by forming the through-hole 31, the spacer member 4 does not have a portion where the restricting portion 22a intersects an upper surface 21a of the bottom wall portion 21. Therefore, it is possible to prevent the corner R shape from being formed in a region where the corner portion 35 of the first core 3A can be disposed. A width (dimension in the Y-axis direction) of the through-hole 31 is not particularly limited, but for example, may have a relationship in which variations in dimension of the core 3A (magnetic body), which is a sintered body, can be absorbed.

A situation in which a corner portion between the side wall portion 22 and the bottom wall portion 21 abuts on the corner portion 35 will be described with reference to FIG. 3(b). FIG. 3(b) illustrates a comparative example in which the corner R shape 37 is formed between the side wall portion 22 and the bottom wall portion 21. When the first core 3A is moved toward the negative side in the Y-axis direction due to positional deviation or the like at the time of installation work, the corner portion 35 of the first core 3A abuts on the corner R shape 37, and rides on the corner R shape 37 while being guided by a curved shape of the corner R shape 37. Alternatively, when the first core 3A is inserted into the spacer member from the positive side to the negative side in the Z-axis direction in a state where the side surface 6a of the first core 3A and the restricting portion 22a are close to or in contact with each other, the corner portion 35 of the first core 3A abuts on the corner R shape 37, and the first core 3A stops before the main surface 3Aa and the upper surface 21a of the bottom wall portion 21 are completely in contact with each other. In these cases, the main surface 3Aa, which is the bottom surface of the first core 3A, is inclined so as to be separated from the upper surface 21a of the bottom wall portion 21. When the corner portion 35 of the first core 3A abuts on the corner R shape 37 of the spacer member 4, the corner portion interferes with the corner R shape 37, and the first core 3A cannot be disposed at a desired position. In this case, the abutment avoidance portion 30 may be regarded as an interference avoidance portion that avoids interference with the corner portion 35 of the first core 3A at the corner portion between the side wall portion 22 and the bottom wall portion 21.

On the other hand, in the core support structure 1 according to the present embodiment illustrated in FIG. 3(a), the corner R shape is not formed. Therefore, when the first core 3A is moved toward the negative side in the Y-axis direction, the corner portion 35 does not abut on the spacer member 4 while the main surface 3Aa is maintained in contact with the upper surface 21a of the bottom wall portion 21, and the side surface 6a comes into contact with the restricting portion 22a (see an imaginary line in FIG. 3(a)). Alternatively, when the first core 3A is inserted into the spacer member from the positive side to the negative side in the Z-axis direction in a state where the side surface 6a of the first core 3A and the restricting portion 22a are close to or in contact with each other, the corner portion 35 of the first core 3A does not abut on the spacer member 4, and the main surface 3Aa and the upper surface 21a of the bottom wall portion 21 are completely in contact with each other.

The through-hole 31 may be filled with a heat conduction member 36. The heat conduction member 36 is coupled to the main surface 3Aa of the first core 3A and is coupled to the main surface 3Ba of the second core 3B. As a result, heat generated in the first core 3A can be transferred to the second core 3B via the heat conduction member 36. Furthermore, the heat of the first core 3A transferred to the second core 3B is transferred to the base plate 2 together with the heat generated in the second core 3B, and is dissipated from the base plate into the air. As a material of the heat conduction member 36, a material that is rich in invasiveness as the initial physical property characteristics, and that is either curable or non-curable as the temporal property change, but a material having thermal conductivity is preferable. A low hardness sheet having thermal conductivity or the like may be adopted as long as the material is limited to thermal conductivity.

Next, operations and effects of the core support structure 1 according to the present embodiment will be described. Note that although the operations and effects obtained by the through-hole 31 among the three abutment avoidance portions 30 will be described here, the same operations and effects can be obtained for the other through-holes 32 and 33.

In the core support structure 1 according to the aspect of the present embodiment, the receiving member 10 has the bottom wall portion 21 on which the main surface 3Aa (bottom surface) of the first core 3A is placed and the side wall portion 22 facing the side surface 6a of the first core 3A. Therefore, the corner portion 35 of the first core is disposed close to the corner portion between the bottom wall portion 21 and the side wall portion 22. Here, the bottom wall portion 21 is formed with the abutment avoidance portion 30 that avoids abutment of the first core 3A with the corner portion 35. Therefore, even when the corner portion 35 of the first core 3A is not chamfered, it is avoided that the corner portion 35 of the first core 3A abuts on and rides on the corner R shape (see FIG. 3(b)) of the receiving member 10, and the first core 3A is installed on the receiving member 10 in a state of being placed on the bottom wall portion 21.

The core support structure 1 further includes the second core 3B disposed opposite to the first core 3A, and the receiving member 10 may be the spacer member 4 disposed between the first core 3A and the second core 3B. In this case, since the first core 3A can be avoided from riding on the receiving member 10, the size of the gap between the first core 3A and the second core 3B can be kept constant.

The abutment avoidance portion 30 may be configured by the through-hole 31 formed in the receiving member 10. In this case, the abutment avoidance portion 30 can be provided with a simple configuration in which only the through-hole 31 is formed in the receiving member 10. In addition, the through-hole 31 can make the spacer member 4 lighter than a groove portion to be described later. In addition, the heat conduction member 36 can be disposed in the through-hole 31.

The through-hole 31 in which the heat conduction member 36 coupled to the first core 3A is disposed may be formed in the receiving member 10. In this case, the heat generated in the first core 3A can be transferred to another member (second core 3B) via the heat conduction member 36 disposed in the through-hole 31.

The present disclosure is not limited to the above-described embodiment.

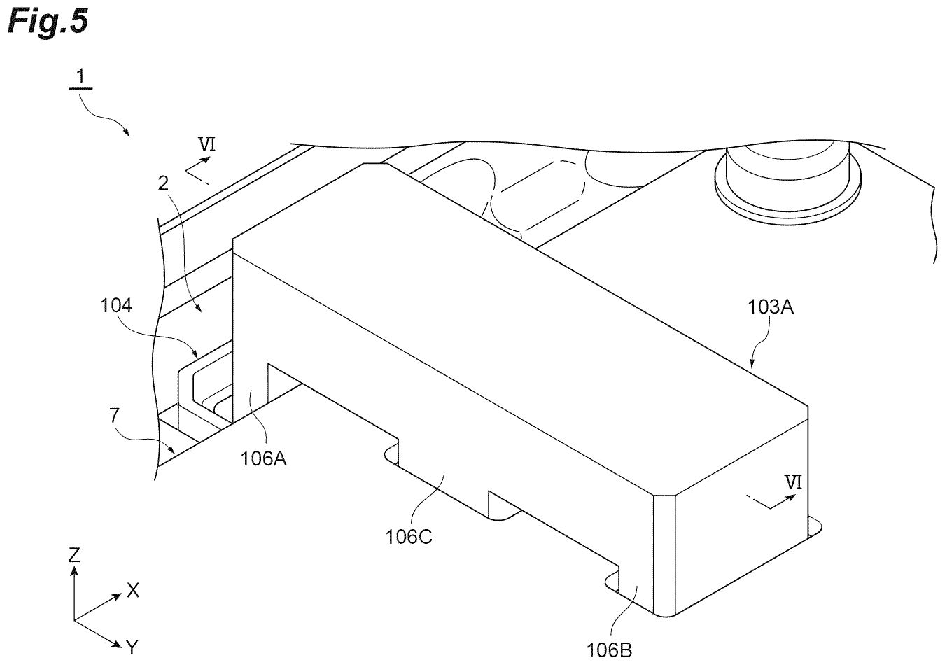

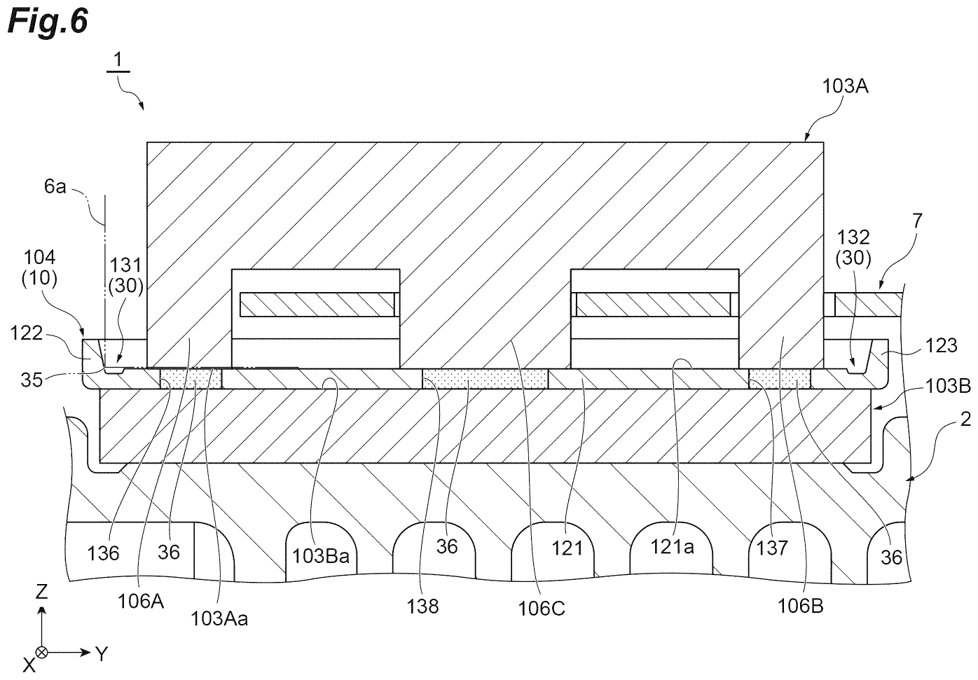

The core support structure 1 illustrated in FIGS. 5 and 6 may be adopted. The core support structure 1 illustrated in FIGS. 5 and 6 is a structure that supports an E-shaped first core 103A and an I-shaped second core 103B (see FIG. 6). The first core 103A has leg portions 106A, 106B, and 106C extending to the negative side in the Z-axis direction so as to be separated from each other in the Y-axis direction. The leg portion 106A is provided at an end portion on the negative side in the Y-axis direction, and the leg portion 106B is provided at an end portion on the positive side in the Y-axis direction. The leg portion 106C is formed between the leg portion 106A and the leg portion 106B. A main surface 103Aa (bottom surface of each leg portion 106A, 106B, and 106C) of the first core 103A is disposed so as to face a main surface 103Ba (upper surface) of the second core 103B disposed on the negative side in the Z-axis direction. A spacer member 104 is a portion that forms a gap between the first core 103A and the second core 103B. The spacer member 104 is configured as the receiving member 10 that receives the first core 3A.

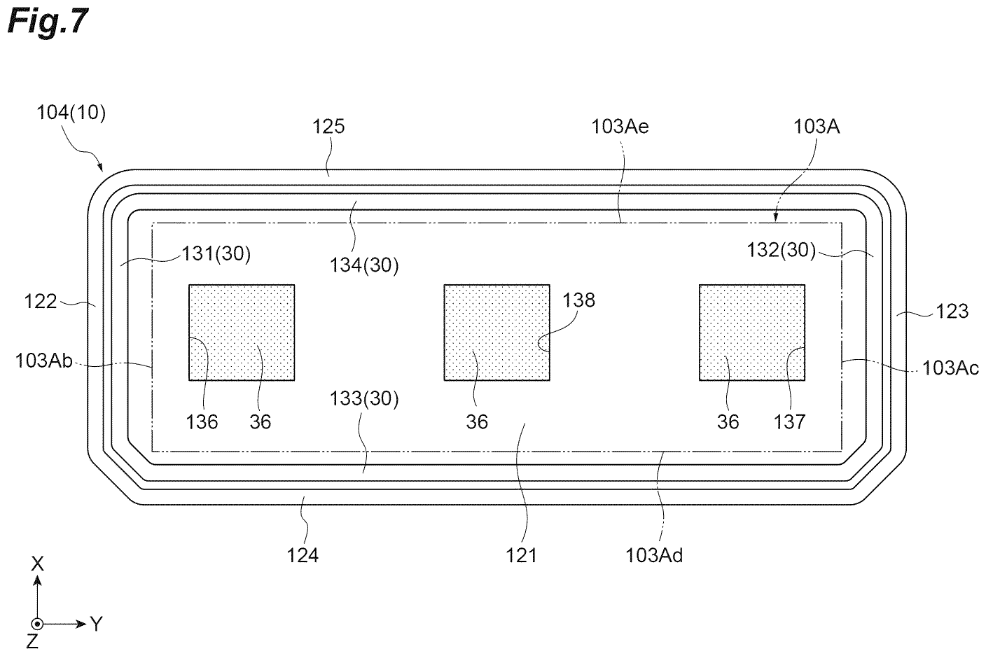

As illustrated in FIG. 7, the spacer member 104 has a bottom wall portion 121 and side wall portions 122, 123, 124, and 125. The bottom wall portion 121 is a wall portion on which the main surface 103Aa which is a bottom surface of the first core 103A is placed. The bottom wall portion 121 is a rectangular wall portion extending parallel to the YX plane. The side wall portions 122, 123, 124, and 125 are provided at four edge portions of the bottom wall portion 121 so as to extend along the edge portions and to extend toward the positive side in the Z-axis direction.

The side wall portion 122 extends in parallel to the X-axis direction at an edge portion of the bottom wall portion 121 on the negative side in the Y-axis direction. As a result, the side wall portion 122 faces a side surface 103Ab of the first core 103A on the negative side in the Y-axis direction, in the Y-axis direction. As a result, the side wall portion 122 faces a side surface 103Ab of the first core 103A on the negative side in the Y-axis direction, in the Y-axis direction. The side wall portion 123 extends in parallel to the X-axis direction at an edge portion of the bottom wall portion 121 on the positive side in the Y-axis direction. As a result, the side wall portion 123 faces a side surface 103Ac of the first core 103A on the positive side in the Y-axis direction, in the Y-axis direction. The side wall portion 124 extends in parallel to the Y-axis direction at an edge portion of the bottom wall portion 121 on the negative side in the X-axis direction. As a result, the side wall portion 124 faces a side surface 103Ad of the first core 103A on the negative side in the X-axis direction, in the X-axis direction. The side wall portion 125 extends in parallel to the Y-axis direction at an edge portion of the bottom wall portion 121 on the positive side in the X-axis direction. As a result, the side wall portion 125 faces a side surface 103Ae of the first core 103A on the positive side in the X-axis direction, in the X-axis direction.

The bottom wall portion 121 is formed with abutment avoidance portions 30 that avoid abutment of the first core 103A with the corner portions. In the present modification, the abutment avoidance portions 30 are formed over the entire circumference at the four edge portions of the bottom wall portion 121. Specifically, the abutment avoidance portions 30 are configured by groove portions 131, 132, 133, and 134 which extend along the four edge portions of the bottom wall portion 121 and are recessed toward the negative side in the Z-axis direction. The groove portion 131 is formed so as to extend in parallel to the side wall portion 122 at a position adjacent to the side wall portion 122 on the positive side in the Y-axis direction. The groove portion 132 is formed so as to extend in parallel to the side wall portion 123 at a position adjacent to the side wall portion 123 on the negative side in the Y-axis direction. The groove portion 133 is formed so as to extend in parallel to the side wall portion 124 at a position adjacent to the side wall portion 124 on the positive side in the X-axis direction. The groove portion 134 is formed so as to extend in parallel to the side wall portion 125 at a position adjacent to the side wall portion 125 on the negative side in the X-axis direction. Further, the groove portions 131, 132, 133, and 134 are continuous at their ends to form a continuous groove portion having a rectangular annular shape.

By forming the groove portions 131, 132, 133, and 134, it is possible to avoid forming the corner R shape between the side wall portions 122, 123, 124, and 125 and the bottom wall portion 121. As a result, it is avoided that the corner portion of the first core 103A abuts on and rides on the corner R shape of the receiving member 10, and the first core 103A is installed on the receiving member 10 in a state of being placed on the bottom wall portion 121.

As illustrated in FIG. 6, the outer peripheral surfaces of the groove portions 131 and 132 on the outer peripheral side are surfaces in which the side surfaces of the side wall portions 122 and 123 are continuous to the negative side in the Z-axis direction so as to form the same plane as the side surfaces of the side wall portions 122 and 123 on the inner peripheral side. The same applies to the relationship between the groove portions 133 and 134 and the side wall portions 124 and 125. The bottom surfaces of the groove portions 131, 132, 133, and 134 may be located at least on the negative side in the Z-axis direction with respect to the upper surface 121a of the bottom wall portion 121, and a depth is not particularly limited. Note that widths of the groove portions 131, 132, 133, and 134 are not particularly limited, but for example, may have a relationship in which variations in dimension of the core 103A (magnetic body), which is a sintered body, can be absorbed.

In the bottom wall portion 121, a through-hole 136 is formed at a position corresponding to the leg portion 106A, a through-hole 137 is formed at a position corresponding to the leg portion 106B, and a through-hole 138 is formed at a position corresponding to the leg portion 106C. The through-holes 136, 137, and 138 are filled with the heat conduction members 36 coupled to each of the leg portions 106A, 106B, and 106C and the second core 103B. In this manner, the through-holes 136, 137, and 138 in which the heat conduction members 36 coupled to the first core 103A are disposed are formed in the receiving member 10. Note that in plan view (state illustrated in FIG. 7), the through-holes 136, 137, and 138 are formed in the size, shape, and position so as to be accommodated inside the leg portions 106A, 106B, and 106C. However, the size, shape, and arrangement of the through-holes 136, 137, and 138 in plan view (state illustrated in FIG. 7) are not particularly limited as long as the leg portions 106A, 106B, and 106C do not fall, and the areas of the through-holes 136, 137, and 138 in plan view may be larger than the areas of the leg portions 106A, 106B, and 106C. The through-holes 136, 137, and 138 may be omitted.

As described above, the abutment avoidance portions 30 may be configured by the groove portions 131, 132, 133, and 134 formed in the receiving member 10. In this case, the abutment avoidance portions 30 can be provided with a simple configuration in which the groove portions 131, 132, 133, and 134 are only formed in the receiving member 10. In addition, when the groove portions 131, 132, 133, and 134 are formed as molded components, the mold only needs to be provided with a protrusion smaller than that in the case of forming the through-holes. The groove portions 131, 132, 133, and 134 and the through-holes 136, 137, and 138 can function as storage portions for holding the surplus heat conduction members 36.

In the example illustrated in FIGS. 1 to 7, the abutment avoidance portions 30 are configured by the through-holes or the groove portions formed in the bottom wall portion. However, since it is only necessary to avoid the corner R shape on which the corner portion of the first core abuts, the abutment avoidance portions 30 may be configured by through-holes or groove portions formed in the side wall portions. Alternatively, the abutment avoidance portion 30 may be configured by a combination of through-holes or groove portions formed in both the bottom wall portion and the side wall portions. The cross-sectional shape of the groove portion is a rectangular cross-sectional shape in FIG. 6, but is not particularly limited, and may be a semicircular shape or the like.

In the examples illustrated in FIGS. 1 to 7, the cross-sectional shape of the leg of the target core is a quadrangular shape, but may be a triangular shape, a polygonal shape of four or more squares, or a circular shape. In each case, continuous groove portions may be formed as the abutment avoidance portions 30 over the entire side and the entire circumference of the bottom wall portion or the side wall portions, or the restricting portion and the through-hole may be disposed at each important point.

The arrangement and shape of each member illustrated in each drawing are merely examples, and can be appropriately changed without departing from the gist of the present disclosure.

### [Aspect 1]

A core support structure comprising:
a first core; and
a receiving member configured to receive the first core, wherein
the receiving member has a bottom wall portion on which a bottom surface of the first core is placed and a side wall portion facing a side surface of the first core, and
an abutment avoidance portion that avoids abutment of the first core with a corner portion is formed on at least one of the bottom wall portion and the side wall portion.

### [Aspect 2]

The core support structure described in the aspect 1, further comprising:
a second core disposed opposite to the first core, wherein the receiving member is a spacer member disposed between the first core and the second core.

### [Aspect 3]

The core support structure described in the aspect 1 or 2, in wherein the abutment avoidance portion is configured by a through-hole formed in the receiving member.

### [Aspect 4]

The core support structure described in any one of the aspects 1 to 3, in wherein the abutment avoidance portion is configured by a groove portion formed in the receiving member.

### [Aspect 5]

The core support structure described in any one of the aspects 1 to 4, in wherein a through-hole in which a heat conduction member coupled to the first core is disposed is formed in the receiving member.

### REFERENCE SIGNS LIST

1 Core support structure
3A, 103A First core
3B, 103B Second core
21, 121 Bottom wall portion
22, 24, 25, 23, 122, 123, 124, 125 Side wall portion
30 Abutment avoidance portion
31, 32, 33 Through-hole
35 Corner portion
131, 132, 133, 134 Groove portion

1. A core support structure comprising:
a first core; and
a receiving member configured to receive the first core, wherein
the receiving member has a bottom wall portion on which a bottom surface of the first core is placed and a side wall portion facing a side surface of the first core, and
an abutment avoidance portion that avoids abutment of the first core with a corner portion is formed on at least one of the bottom wall portion and the side wall portion.

2. The core support structure according to claim 1, further comprising:
a second core disposed opposite to the first core, wherein
the receiving member is a spacer member disposed between the first core and the second core.

3. The core support structure according to claim 1, wherein the abutment avoidance portion is configured by a through-hole formed in the receiving member.

4. The core support structure according to claim 1, wherein the abutment avoidance portion is configured by a groove portion formed in the receiving member.

5. The core support structure according to claim 1, wherein a through-hole in which a heat conduction member coupled to the first core is disposed is formed in the receiving member.
